(19) United States
(12) Patent Application Publication
(10) Pub. No.: US 2018/0024272 A1
(43) Pub. Date: Jan. 25, 2018

(54) METHODS AND SYSTEMS FOR COMMUNICATING INFORMATION TO A USER

(71) Applicant: Kabushiki Kaisha Toshiba, Minato-ku, Tokyo (JP)

(72) Inventors: Eirini SPYROPOULOU, Bristol (GB); Yichao JIN, Bristol (GB); Mahesh SOORIYABANDARA, Bristol (GB)

(73) Assignee: Kabushiki Kaisha Toshiba, Minato-ku, Tokyo (JP)

(21) Appl. No.: 15/546,318

(22) PCT Filed: Sep. 11, 2015
(86) PCT No.: PCT/GB2015/052633

§ 371 Date: Jul. 26, 2017

(51) Int. Cl. G01W 1/17

(52) U.S. Cl. CPC G01W 1/17; G06F 17/2785

(57) ABSTRACT

A computer implemented method for communicating information to a user; the method including: receiving, from one or more sensors, sensor data containing values of one or more parameters monitored by the sensors; receiving, from one or more users, semantic data for use in interpreting the values of the one or more parameters contained in the sensor data; storing the received semantic data in association with the values of the parameters; receiving a request from a user for information relating to one or more of the parameters at a specified location; determining a value of the one or more parameters at the specified location based on the received sensor data; identifying semantic data that reflects the determined value(s) of the one or more parameters, based on the stored semantic data and stored values of the parameters; and sending the identified semantic data to the user that issued the request.

### FIELD

Embodiments described herein relate to methods and systems for communicating information to a user.

### BACKGROUND

The increasing deployment of different types of sensor around cities provides opportunities for applications to update citizens with real-time information about the environment. In order for this information to be useful, and inform immediate decisions, it is desirable for the information to be translated into an easily understood description of the sensor readout. As one example, it is more useful to inform users that it is difficult to breathe in a particular area of a city, than to simply provide those users with numerical measurements of carbon dioxide concentration, humidity and temperature.

In order to translate the numerical data into a meaningful description, it is necessary to provide semantic labels that correspond to the sensor data. Conventional systems achieve this manually, by using dedicated external annotators or experts to tag the sensor data offline. Such systems can provide information to users with short delays. However, they can be inefficient in terms of energy and bandwidth usage, as well as being costly to implement.

### BRIEF DESCRIPTION OF DRAWINGS

Embodiments of the invention will now be described by way of example with reference to the accompanying drawings in which:

FIG. 1 shows an example of a system according to an embodiment;

FIG. 2 shows a flow-chart illustrating how sensor data may be stored in association in with sematic data in an embodiment;

FIG. 3 shows a pictorial representation of the steps shown in FIG. 2;

FIG. 4 shows a schematic of a server according to an embodiment;

FIG. 5 shows a flow-chart of steps used in providing information in response to a user request, in accordance with an embodiment;

FIG. 6 shows a pictorial representation of the steps shown in FIG. 5;

FIG. 7 shows a flow-chart of steps used in providing information in response to a user request, in accordance with another embodiment;

FIG. 8 shows an example of a system according to another embodiment;

FIG. 9 shows an example of a system according to another embodiment; and

FIG. 10 shows a performance comparison between a system according to an embodiment and conventional systems.

### DETAILED DESCRIPTION

According to a first embodiment, there is provided a computer implemented method for communicating information to a user; the method comprising:
receiving, from one or more sensors, sensor data containing values of one or more parameters monitored by the sensors;
receiving, from one or more users, semantic data for use in interpreting the values of the one or more parameters contained in the sensor data;
storing the received semantic data in association with the values of the parameters,
receiving a request from a user for information relating to one or more of the parameters at a specified location;
determining a value of the one or more parameters at the specified location based on the received sensor data;
identifying semantic data that reflects the determined value(s) of the one or more parameters, based on the stored semantic data and stored values of the parameters; and
sending the identified semantic data to the user that issued the request.

In some embodiments, the semantic data is stored in association with values of the parameters that have been received in the same time window as the semantic data, and/or which have been received from the same location as said semantic data.

In some embodiments, the semantic data comprises one or more words or phrases provided by the users; wherein
in response to receiving the request from the user, a determination is made as to the level of confidence with which the one or more words or phrases can be considered to reflect the determined value(s) of the one or more parameter(s); and
in the event that the level of confidence is below a threshold for each of the one or more words or phrases, a request is sent to the one or more users to send further semantic data.

In some embodiments, the method comprises receiving further semantic data from the one or more users in response to the request, and storing the further semantic data in association with sensor data that is received in the same time window as the further semantic data or which originates from the same location as the further semantic data.

In some embodiments, the level of confidence with which a respective word or phrase is considered to reflect the determined value(s) of the one or more parameter(s) is determined at least in part based on the number of times the word or phrase appears in the semantic data that is stored in association with values of sensor data that are deemed to correspond to the determined value(s) of the parameter(s) at the specified location.

In some embodiments, the values of stored sensor data that are deemed to correspond to the determined value(s) of the parameter(s) at the specified location are values that lie within a predetermined range of the determined value(s).

In some embodiments, the sensor data contains values of a plurality of parameters and the method comprises:
in response to receiving the request from the user, determining a set of values for the parameters, wherein each value in the set comprises a value for a respective one of the parameters at the specified location;
identifying semantic data that reflects the values of the parameters in the set, based on the stored semantic data and stored values of the parameters; and
sending the identified semantic data to the user that issued the request.

In some embodiments, a determination is made as to the level of confidence with which the set of values of parameters can be considered to reflect the value of each parameter in the specified location.

In some embodiments, the semantic data comprises one or more words or phrases provided by the users; wherein
in response to receiving the request from the user, a determination is made as to the level of confidence with which the one or more words or phrases can be considered to reflect the determined set of values;
in the event that the level of confidence is below a threshold for each of the one or more words or phrases, a request is sent to the one or more users to send further semantic data.

In some embodiments, the method comprises receiving further semantic data from the one or more users in response to the request, and storing the further semantic data in association with sensor data that is received in the same time window as the further semantic data or which originates from the same location as the further semantic data.

In some embodiments, the level of confidence with which a respective word or phrase is considered to reflect the determined set of values is determined at least in part based on the number of times the word or phrase appears in the semantic data that is stored in association with values of sensor data that are deemed to correspond to the determined set of values.

In some embodiments, the values of stored sensor data that are deemed to correspond to the determined set of values of the parameters at the specified location are values that lie within a predetermined range of the determined set of values.

In some embodiments, the one or more sensors are environmental sensors, and the sensor data indicates values of one or more environmental parameters.

In some embodiments, the environmental parameters include one or more of temperature, humidity and noise level in the vicinity of the sensor(s).

In some embodiments, knowledge is created in the form of machine generated, human interpretable information, by mapping the values of measured parameters to the received semantic data.

According to a second embodiment, there is provided a non-transitory computer readable medium comprising computer executable instructions that when executed by a computer will cause the computer to carry out a method according to any one of the preceding claims.

According to a third embodiment, there is provided a computer system for receiving and communicating information to a user; the system comprising:
a server configured to receive, from one or more sensors, sensor data containing values of one or more parameters monitored by the sensors, the server further being configured to receive, from one or more users, semantic data for use in interpreting the values of the one or more parameters contained in the sensor data;
a database for storing the received semantic data in association with the values of the parameters;
the server comprising a processor for determining a value of the one or more parameters at the specified location based on the received sensor data; the processor being configured to identify semantic data that reflects the determined value(s) of the one or more parameters, based on the stored semantic data and stored values of the parameters;
the server being configured to send the identified semantic data to the user that issued the request.

In embodiments described herein, a system including a plurality of sensors is provided, which can autonomously create knowledge in the form of an association between semantic labels and numerical data, whilst minimising the need for external input. The system gathers the required semantic labels by crowd sourcing them through its own users, who may supply the labels using personal communication devices, including mobile phones, laptops, tablets etc. The crowd sourcing works in combination with iterative model building and as such it is uncertainty and user request driven.

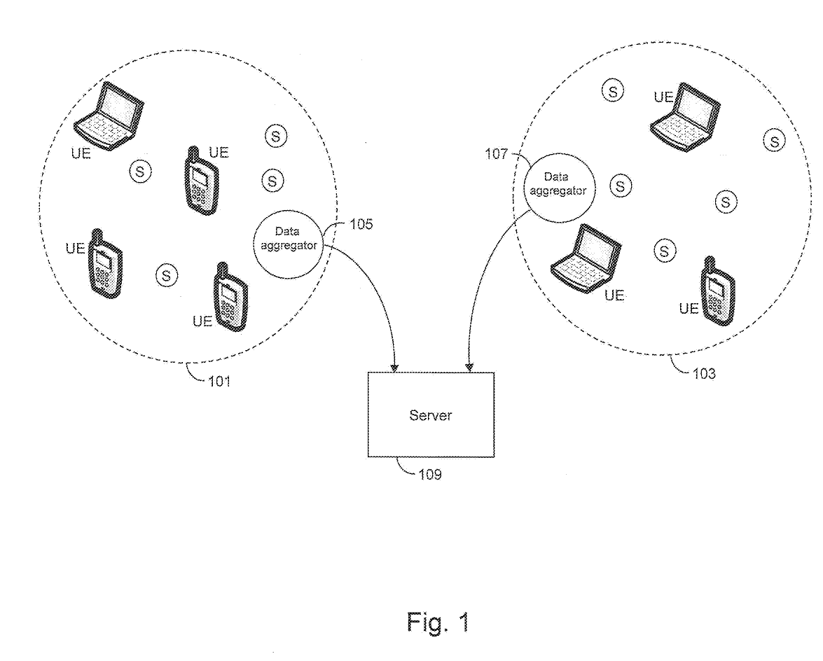

FIG. 1 shows an example of a system according to an embodiment. The system includes a plurality of sensors (S), which are located in two different geographic regions 101, 103. The sensors are used to sense values of one or more parameters within their respective regions 101, 103 (these parameters may, for example, be environmental parameters such as temperature, humidity etc. but could also be other parameters such as the noise level in decibels, or a measure of how crowded the region is as represented by the number of people passing the sensor in a given time window, for example). Located within each region are various users who each have a personal communication device or user equipment (UE). The personal communication devices may include, for example, mobile phones, personal computers, laptops, tablets etc. Some or all of the personal communication devices may also include their own sensor similar to the other sensors S, although this is not essential.

Each region also has an associated data aggregator 105, 107. The data aggregator is used to collect sensor data in the form of sensor measurements from the various sensors and semantic data from the user's personal communication devices. The semantic data is comprised of labels or tags i.e. a short textual description of the parameters being measured by the sensors. For example, in the case where the sensors are used to monitor temperature, the semantic data may include statements such as “hot”, “warm”, “cold” etc. The users enter the semantic data onto their personal communication devices through a standard user interface; this may comprise the use of a dedicated software application, or alternatively may involve the user's drafting an SMS text message or other form of written message in their device.

The sensors S transmit the sensor data over one or more communications channels to the respective data aggregator in their region. The communication channel(s) may include any one of a number of standard channels as known in the art, including a wired connection, cellular network, wireless LAN etc. Similarly, the users may transmit the semantic data to the data aggregator over one or more communication channels, which may be the same or different channel(s) as used for sending the sensor data. Each data aggregator aggregates the sensor data received from the sensors in its region. The aggregator in turn forwards the aggregated sensor data, together with the semantic data received from the user devices, to a server 109. In this way, the server 109 receives aggregated sensor readings and semantic data from the different regions 101, 103. The server can then use the sensor readings and semantic data to build up a knowledge base for associating particular values of the measured parameters with descriptions of those parameters. In essence, the server is able to accrue knowledge in the form of machine generated, but human interpretable information, by mapping the values of measured parameters to descriptions of those parameters.

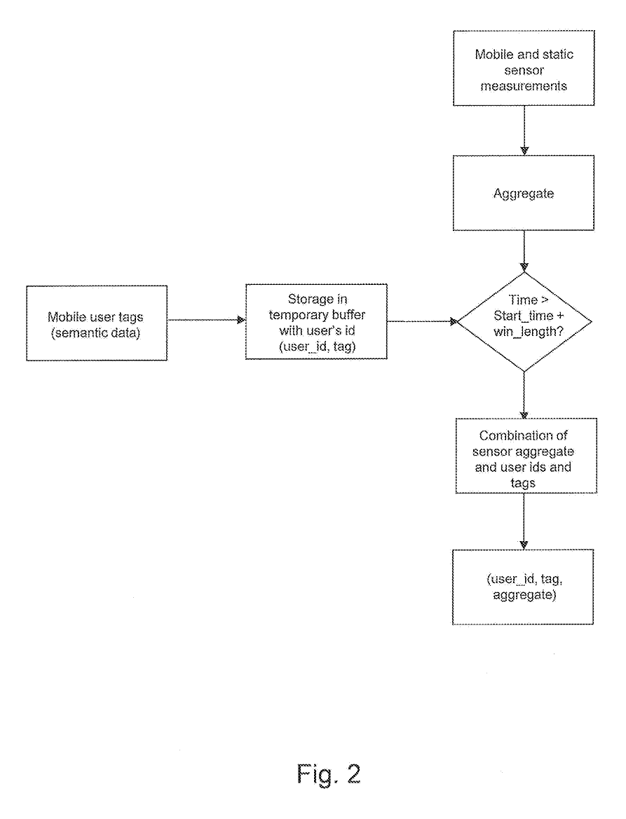

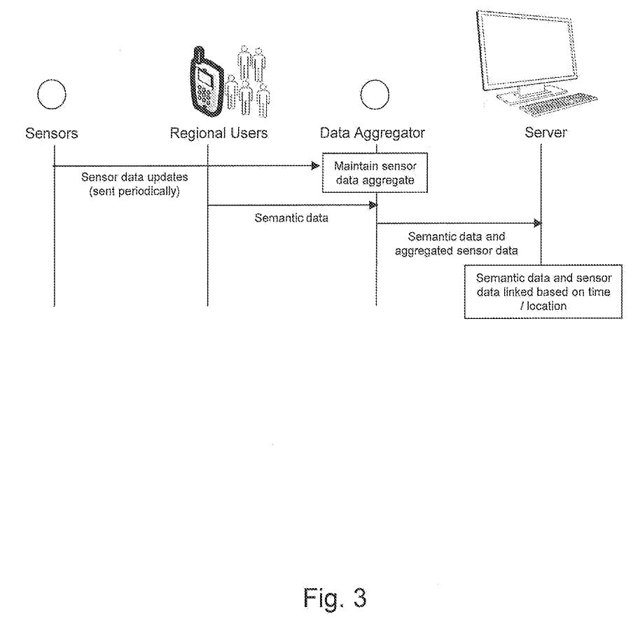

FIG. 2 shows a flow-chart illustrating how the sensor data may be stored in association with received semantic data in the database. Sensor data from the mobile and/or static sensors in a particular region are forwarded to that region's data aggregator, which forms an aggregate of the received sensor readings. Independently of this, semantic data labels, as input by users within the same region, are forwarded to and buffered within the data aggregator. If the semantic data and aggregated sensor readings are received within a certain interval (window length) of one another, a decision is made to store the semantic labels and the sensor readings in association with one another in the server database. The duration of the interval can be set to be any chosen length. The steps shown in FIG. 2 are illustrated pictorially in FIG. 3.

By recording the time and location from which the semantic data and the sensor data originate, it is possible to correlate those data with one another; in the event that sensor data and semantic data originate from the same time and place, one can infer that those data are likely to reflect the same parameter value(s).

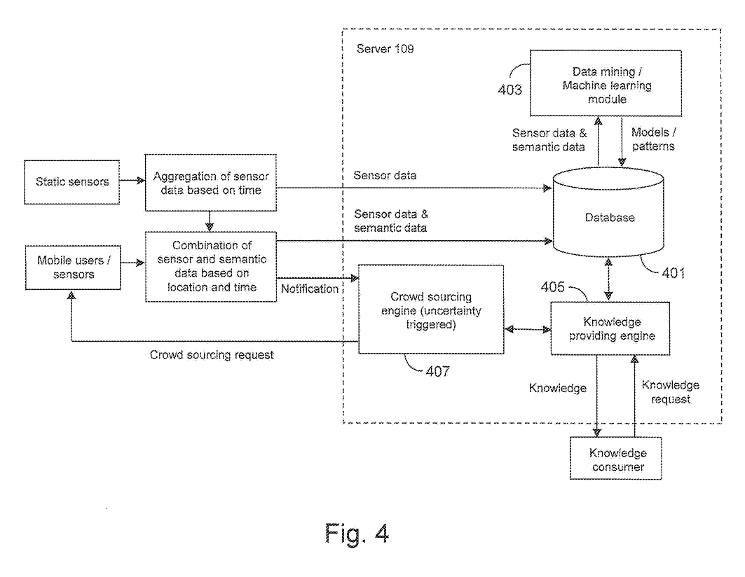

FIG. 4 shows a schematic of the components of the server of FIG. 1 in more detail. In the present embodiment, the server 109 includes a database 401, a data mining or machine learning module 403, a knowledge providing engine 405 and a crowd sourcing engine 407.

The database 401 is used to store data received from the data aggregator(s) in the respective regions. As described above, the sensor data and semantic data may be stored in association with one another based on the time at which they are generated, and/or the location or region from which they originate.

The data mining module 403 is configured to analyse the data in the database and to establish relationships between the two types of data within the database; the data mining module is used to establish a link between a particular numerical value, or group of numerical values, and a particular semantic label. For example, the data mining module may determine that values of temperature above a certain threshold tend to be associated with a semantic label of “hot”, whilst those beneath that threshold tend to be associated with a different semantic label, such as “cold”.

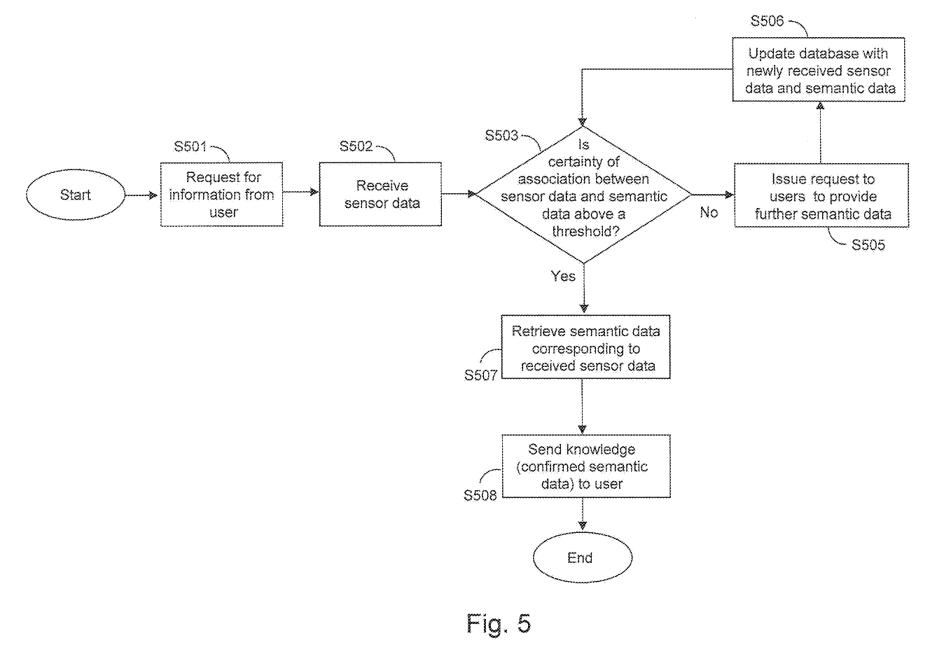

The knowledge providing engine 405 is used to provide readouts to user's requests for information concerning a measured parameter in a particular region. The steps involved in providing this information are summarised in the flow-chart of FIG. 5. Referring to FIG. 5, a user may send a request to the server to provide information about another region (step S501). In response to the request, the server may consult the database 401 for the most recently received sensor data for that region (S502). Then, working in conjunction with the data mining/machine learning module, the knowledge providing engine may identify the semantic data that most likely reflects the value(s) of the parameter in the region of interest and send that semantic data to the user.

The knowledge providing engine will only send a semantic tag or label to the user if it determines that the certainty with which the particular semantic label is associated with the measured sensor readings is above a threshold. For example, in the case where the sensor data relates to temperature, the knowledge providing engine will not send a reading of “hot” to the user unless it is determined to within a specified degree of certainty that the term “hot” is a true reflection of the temperature in the region of interest. The certainty of association between the sensor data and a particular semantic label is determined in step S503, in conjunction with the data mining module; as described below, there may be different ways of establishing whether or not the certainty is great enough to permit the semantic data being sent to the user.

In the event that the knowledge providing engine determines that it does not possess sufficient certainty to warrant sending of a particular semantic label to the user, the knowledge providing engine may prompt the crowd sourcing engine to issue a request for users in the region of interest to provide updated semantic labels, reflective of the current value of the parameter in question (step S505). The crowd sourcing engine 407 may issue the request in the form of an email, SMS message or other electronic communication, which may be received at the users' personal communication devices. The semantic labels received from the users in response to the crowd sourcing request can be used to respond to the initial user's request for information about the region of interest. In addition, the newly received semantic labels can be added to the database (step S506), where they can aid the data mining module in thereafter establishing appropriate semantic labels to match with particular values of sensor data.

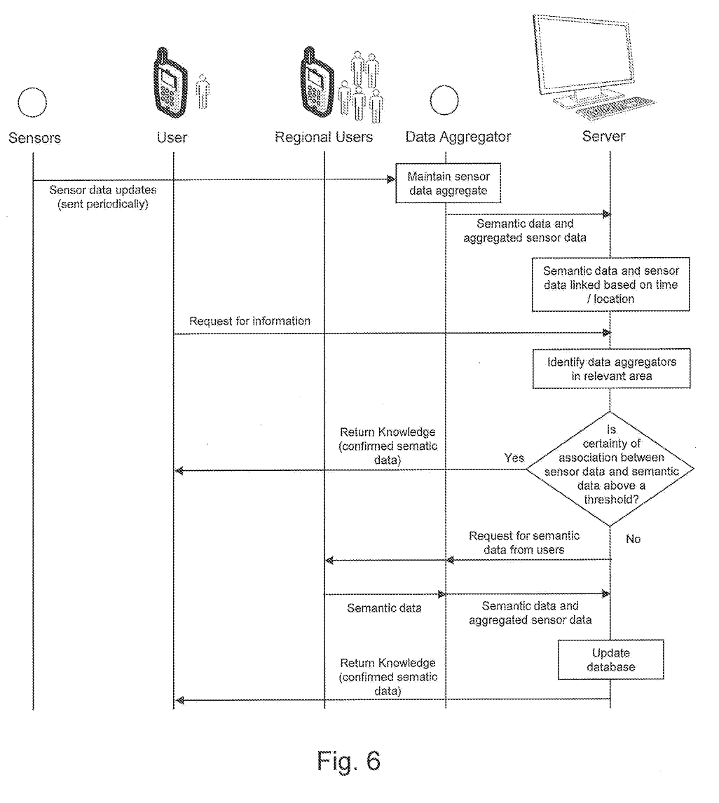

The process described above may be repeated over time. As the amount of data stored in the database 401 increases with each crowd sourcing request, there will be a concomitant increase in the certainty with which the data mining module/machine learning module and knowledge providing engine are able to correlate particular numerical values of sensor data with particular sematic labels. Thus, at a certain point, the knowledge providing engine will no longer need to prompt the crowd sourcing engine to request input from users, but will be able to identify an appropriate semantic label to send to a user based on the data already stored in the database and the relationships identified by the data mining/machine learning module. At this point, the method will proceed to steps S507 and S508. The steps of the method according to the present embodiment are also shown pictorially in FIG. 6.

A number of means may be employed for defining the certainty with which a particular semantic label can be said to reflect the value of one or more parameters in the sensor data. In some embodiments, machine learning may be used to identify associations between the received sensor data and semantic data. In one example, the system may wait until a predetermined number of results has been obtained (for example, the system may require that a threshold number of crowd sourcing requests has been issued), after which the system may associate a particular sensor data value with the semantic label that is most commonly seen to be associated with that sensor data value in the database. The server may still continue to send crowd sourcing requests at intervals (repeating steps S505 and S506 of FIG. 5) in order to add to the amount of data stored in the database and in turn review the selection of the semantic label accordingly.

In another embodiment, pattern mining may be used. Pattern mining operates over categorical data and outputs frequent combinations of data values. Pattern mining is applicable for cases in which the sensor data comprises more than one parameter; for example, pattern mining may be applicable where the sensor data includes measurements of both temperature and humidity, rather than just temperature alone. In one embodiment in which pattern mining is used, the server may derive the probability that a particular set of sensor measurements reflect the true value of those parameters in the region of interest.

By way of example, continuing with the case in which the sensor data relates to temperature and humidity readings, the server will receive multiple readings of both temperature and humidity from the sensors located in the region of interest. In this case, the server may determine an aggregate vector “m” where m comprises a single value for each one of the sensed parameters—the vector m may be represented as m={5° C., 5% humidity}, for example. The server will estimate a probability density function “P” of the sensor measurements using kernel density estimation. Following this, the server will compute P([m−r, m+r]), where r is an application specific parameter. If the value of P([m−r, m+r]) is large enough, the server can determine that there is sufficient certainty about this vector of measurements; that is, the server can determine that the selected combination of values for the different parameters in the vector m provide a true reflection of the conditions in the region of interest.

The server will next query the database to identify users and tags that are stored in association with sensor measurements in the region [m−t, m+t] where t is a user defined threshold. Having done so, a single relation data mining technique such as frequent item-set mining can be applied on the results to find the most popular (and, by extension, the most relevant) combination of tags for the current sensor data measurements.

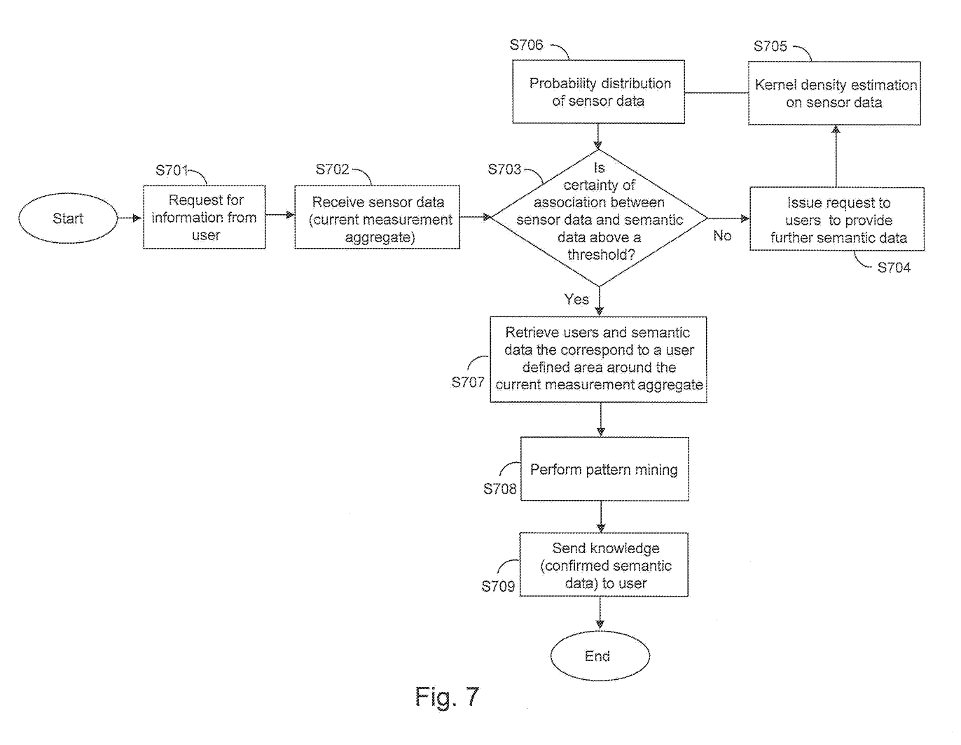

If P([m−r, m+r]) is too small (using a user defined threshold), then there will be insufficient certainty in the database about the vector of measurements. In this case, the server will initiate crowd sourcing via the gateways for which the current vector of measurements is close to m. After it receives all the information and the database is updated, pattern mining can be performed. These steps are summarised in the flow-chart of FIG. 7.

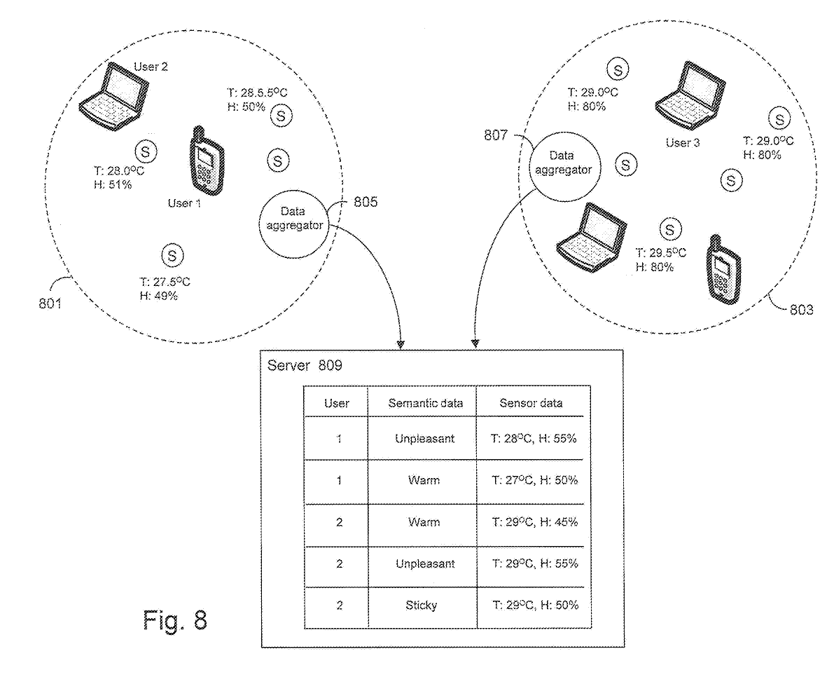

FIG. 8 shows an example of how a system according to an embodiment may be used to provide information about the environmental conditions in a region 801 to a user located in a different region 803. As in the example shown in FIG. 1, each region includes one or more static or mobile sensors S for measuring the value of one or more parameters (in the present case, temperature and humidity). The sensors send their measurements to a data aggregator 805, 807 in their respective region. The data aggregators also receive semantic labels sent from the users in the same region. The aggregated sensor data is then forwarded, together with the semantic data to the server 809.

In the present example, there are two users (user1 and user2) located in the first region 801. A third user (user3) located in the second region 803 sends a request for information about the first region 801 to the server 809.

The table shown in FIG. 8 represents a snapshot of the server's database at the time the user3 issues the request for information. More specifically, the table shows those rows of the database for which the sensor measurements lie within a specified threshold (in this case +/−5%) of the most recently received sensor measurements. (The precise threshold to be used may be specified by the user). Each row includes the sensor measurement(s), together with a semantic label that was received in the same time window and from the same region as those sensor measurements, and an ID of the user who supplied the semantic label.

In the present case, the mean temperature and humidity readings obtained from the most recent batch of sensor data in the first region 801 are T: 28° C. and H: 50, where the letters T and H stand for temperature and humidity, respectively. Thus, the table includes rows for which the sensor data lies in the interval T: 28° C. +/−5% and H: 50% +/−5%.

As can be seen, the table includes 2 entries from user1, and 3 entries from user2. The knowledge providing engine determines the most frequent combination of tags that users agree on i.e. “warm” and “unpleasant”. Following this, the knowledge providing engine is able to infer that conditions in the interval T: 28° C+/−5% and H: 50%+/−5% are considered as warm and unpleasant. The knowledge providing engine in turn generates a message for sending to user3 of the form “most people think that current conditions in the region 1 are warm and unpleasant.”

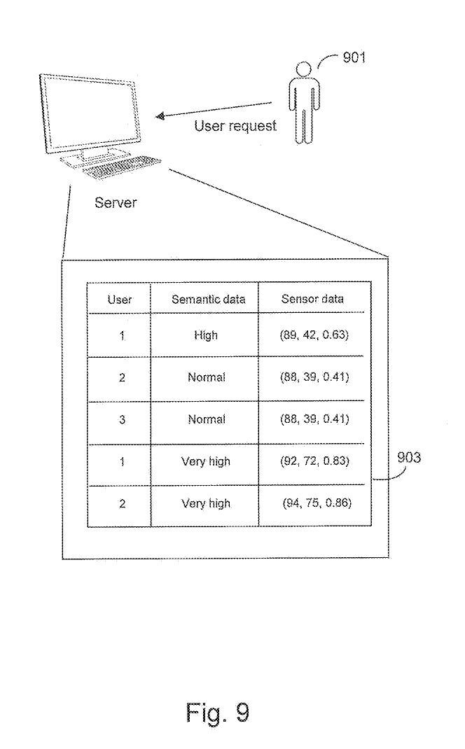

FIG. 9 shows an example of knowledge query and extraction for machine learning. A user 901 would like to determine how disruptive, in terms of noise, a new construction site in a city is likely to be for the citizens at different times of the day. In this embodiment, the user obtains measurements of different noise parameters, such as amplitude and MFCC values (Mel-Frequency Cepstral Coefficients) from microphone sensors at different times of the day. For each such measurement, the user asks the system to specify how loud those measurements are perceived to be.

In response to a user's enquiry about the current noise level at the site, the knowledge providing engine extracts a feature vector from the most recent set of sensor measurements; as before, the feature vector comprises a list of values for the different parameters, in this case the different noise parameters described above. The server then consults the database to identify semantic labels that correspond to the values in the feature vector. Referring still to FIG. 9, the table 903 shows those rows of the database for which the sensor measurements lie within a specified threshold of the feature vector. The table includes 2 entries from a first user, 2 entries from a second user, and one entry from a third user. Each row includes the sensor measurements, together with a semantic label that was received in the same time window and from the same region as those sensor measurements, and an ID of the user who supplied the semantic label. In the present example, the server is able to return the message that “current conditions in the area are perceived as very loud.”

Embodiments described herein provide an improved system in terms of flexibility/cost, average delay of response, average energy consumption of the mobile devices of the users and average bandwidth usage. Embodiments provide increased flexibility since they do not require external experts to provide labels for the sensor data. As a result, applications can be launched directly and provide knowledge to users immediately through the dynamic synergy of model building and crowd sourcing.

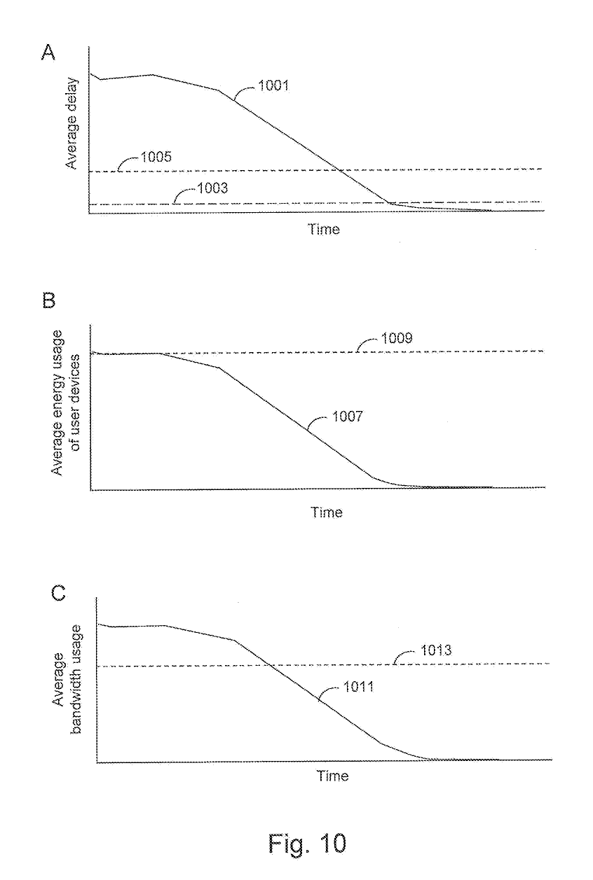

FIG. 10A shows a comparison between the average delay of response of a system according to an embodiment and two conventional types of system. Here, the line 1001 shows how the average delay varies with time for a system according to an embodiment, the line 1003 shows the trend in the average delay for a conventional system that employs continuous data updates, and the line 1005 shows the trend in the average delay for a conventional system that relies on user triggered data updates (here, the term “data” refers both to the sensor and semantic data).

It can be seen that the average delay of response for the system employing a continuous data update (line 1003) is very small; this is because the system always has the most recent data in hand for sending to a user upon receipt of that user's request. Thus, there is no lag time between receiving a request for information and transmitting the data in response. For systems that use user triggered data updates (line 1005), a delay is incurred each time a user requests information as the system needs to first source the semantic data from the users before responding. For both of these conventional types of system, the average delay in responding to the users' requests remain constant over time.

In contrast, in embodiments described herein, the average delay in responding to a user's request for information is initially larger than the conventional systems, but the delay decreases over time and converges to a level which is similar to that of continuous data update systems and smaller than the user triggered systems. The delay is initially larger because the processing (data mining) carried out for every user request after crowd-sourcing, is very heavy. However, as more data is gathered, and more knowledge is produced and stored, there is less need to crowd-source for semantic data and less need for processing as well. The sensor data is also periodically updated. Therefore, the average delay of response in embodiments decreases as the system is used and converges at a level which is similar to that of continuous data update systems and smaller than the user triggered systems. At this point, there is almost no need to crowd source and process data in response to a user's request. The rate at which the average delay decreases will depend on the true data distribution (its skewness, variance etc).

FIG. 10B shows a comparison between the average energy usage of a system according to an embodiment (as shown by line 1007) and a conventional system in which the update of data is user triggered (as shown by line 1009). Initially, the system of the present embodiment has a similar energy usage to the conventional system because it is necessary to build up a store of knowledge and so all user requests lead to crowd sourcing of semantic data. Energy consumption is, therefore, increased as the users are required to transmit the semantic data to the server. However, after a certain period, the energy usage of the personal communications devices begins to fall as the server has sufficient data to respond to requests without the need to crowd-source semantic data from the users. As a result, the energy consumption will, over time, converge to a lower level than the conventional user triggered system.

FIG. 10C shows a comparison between the bandwidth usage of a system according to an embodiment (as shown by line 1011) and a conventional system in which the update of data is user triggered (as shown by line 1013). In the present embodiment, the average bandwidth usage is initially expected to be higher than a system using user-triggered data updates; this follows because the sensor data continues to be updated periodically updated and, in the early stages, the semantic data must still be crowd sourced for every user request. However, as the system gathers more data there is less and less need to crowd source the semantic data. Therefore, over time, the bandwidth usage drops below that of user triggered data update system. Since the sensor data continues to be periodically updated, the bandwidth usage will ultimately converge to a level similar to or less than that of a system that uses continuous data updates.

While certain embodiments have been described, these embodiments have been presented by way of example only and are not intended to limit the scope of the invention. Indeed, the novel methods, devices and systems described herein may be embodied in a variety of forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

1. A computer implemented method for communicating information to a user; the method comprising:
receiving, from one or more sensors, sensor data containing values of one or more parameters monitored by the sensors;
receiving, from one or more users, semantic data for use in interpreting the values of the one or more parameters contained in the sensor data;
storing the received semantic data in association with the values of the parameters,
receiving a request from a user for information relating to one or more of the parameters at a specified location;
determining a value of the one or more parameters at the specified location based on the received sensor data;
identifying semantic data that reflects the determined value(s) of the one or more parameters, based on the stored semantic data and stored values of the parameters; and
sending the identified semantic data to the user that issued the request.

2. A method according to claim 1, wherein the semantic data is stored in association with values of the parameters that have been received in the same time window as the semantic data, and/or which have been received from the same location as said semantic data.

3. A method according to claim 2, wherein the semantic data comprises one or more words or phrases provided by the users; wherein
in response to receiving the request from the user, a determination is made as to the level of confidence with which the one or more words or phrases can be considered to reflect the determined value(s) of the one or more parameter(s); and
in the event that the level of confidence is below a threshold for each of the one or more words or phrases, a request is sent to the one or more users to send further semantic data.

4. A method according to claim 3, comprising receiving further semantic data from the one or more users in response to the request, and storing the further semantic data in association with sensor data that is received in the same time window as the further semantic data or which originates from the same location as the further semantic data.

5. A method according to claim 3, wherein:
the level of confidence with which a respective word or phrase is considered to reflect the determined value(s) of the one or more parameter(s) is determined at least in part based on the number of times the word or phrase appears in the semantic data that is stored in association with values of sensor data that are deemed to correspond to the determined value(s) of the parameter(s) at the specified location.

6. A method according to claim 5, wherein the values of stored sensor data that are deemed to correspond to the determined value(s) of the parameter(s) at the specified location are values that lie within a predetermined range of the determined value(s).

7. A method according to claim 2, wherein the sensor data contains values of a plurality of parameters and the method comprises:
in response to receiving the request from the user, determining a set of values for the parameters, wherein each value in the set comprises a value for a respective one of the parameters at the specified location;
identifying semantic data that reflects the values of the parameters in the set, based on the stored semantic data and stored values of the parameters; and
sending the identified semantic data to the user that issued the request.

8. A method according to claim 7, wherein a determination is made as to the level of confidence with which the set of values of parameters can be considered to reflect the value of each parameter in the specified location.

9. A method according to claim 7, wherein the semantic data comprises one or more words or phrases provided by the users; wherein
in response to receiving the request from the user, a determination is made as to the level of confidence with which the one or more words or phrases can be considered to reflect the determined set of values;
in the event that the level of confidence is below a threshold for each of the one or more words or phrases, a request is sent to the one or more users to send further semantic data.

10. A method according to claim 9, comprising receiving further semantic data from the one or more users in response to the request, and storing the further semantic data in association with sensor data that is received in the same time window as the further semantic data or which originates from the same location as the further semantic data.

11. A method according to claim 9, wherein:
the level of confidence with which a respective word or phrase is considered to reflect the determined set of values is determined at least in part based on the number of times the word or phrase appears in the semantic data that is stored in association with values of sensor data that are deemed to correspond to the determined set of values.

12. A method according to claim 5, wherein the values of stored sensor data that are deemed to correspond to the determined set of values of the parameters at the specified location are values that lie within a predetermined range of the determined set of values.

13. A method according to claim 1, wherein the one or more sensors are environmental sensors, and the sensor data indicates values of one or more environmental parameters.

14. A method according to claim 13, wherein the environmental parameters include one or more of temperature, humidity and noise level in the vicinity of the sensor(s).

15. A method according to claim 1, wherein knowledge is created in the form of machine generated, human interpretable information, by mapping the values of measured parameters to the received semantic data.

16. A non-transitory computer readable medium comprising computer executable instructions that when executed by a computer will cause the computer to carry out a method according to claim 1.

17. A computer system for receiving and communicating information to a user; the system comprising:
a server configured to receive, from one or more sensors, sensor data containing values of one or more parameters monitored by the sensors, the server further being configured to receive, from one or more users, semantic data for use in interpreting the values of the one or more parameters contained in the sensor data;
a database for storing the received semantic data in association with the values of the parameters;
the server comprising a processor for determining a value of the one or more parameters at the specified location based on the received sensor data; the processor being configured to identify semantic data that reflects the determined value(s) of the one or more parameters, based on the stored semantic data and stored values of the parameters;
the server being configured to send the identified semantic data to the user that issued the request.
